(19) United States
(12) Patent Application Publication
(10) Pub. No.: US 2007/0294411 A1
(43) Pub. Date: Dec. 20, 2007

(54) Methods, Apparatuses, a System and Computer Program Products for Providing Early Session Media to Announce Another Media Session

(75) Inventor: Vesa-Matti Hakkarainen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/425,165

(22) Filed: Jun. 20, 2006

(51) Int. Cl. G06F 15/16

(52) U.S. Cl. 709/227

(57) ABSTRACT

An apparatus for providing early session media to announce another media session includes a processing element. The processing element is configured to communicate an invitation for a target terminal to receive early session media content, provide the early session media content to the target terminal in response to acceptance of the invitation, and initiate the other media session with the target terminal in response to acceptance of the early session media content. The invitation includes an attribute that is indicative of a corresponding other media session associated with the early session media content.

### TECHNOLOGICAL FIELD

Embodiments of the present invention relate generally to annunciation techniques, and, more particularly, relate to a method, apparatus, and computer program product for providing early session media to announce another media session.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the ease of information transfer and convenience to users involves the provision of calling features. Call annunciation is an example of such a feature. It is currently common for mobile terminals, such as mobile telephones, to offer various different ringing tones which may be selected by users of the mobile terminals according to individual preferences. However, beyond the provision of conventional audio ringing tones, there is a current demand to provide other media such as music or recorded media for more personalized call annunciation. Additionally, methods have been proposed in which, when a mobile terminal receives a call from a particular caller that is associated with an image, the image may be displayed to alert the user of the mobile terminal of the call.

The call annunciation mechanisms described above each require the content used for alerting the user to be located at the mobile terminal receiving the call. Thus, personalized call annunciation typically relate to personalization performed by the receiver of the call and the caller is limited in ability to personalize the annunciation of his or her calls made to other individuals. For example, the receiver of the call may define particular media stored at the mobile terminal to be played to announce receipt of a particular call. Additionally, certain methods may enable a receiver of the call to access media specified in a message, which could be used for annunciating a call. However, such methods require increased network resource consumption and setup times. Accordingly, there has been a need to provide a mechanism which enables a caller to personalize call annunciation without substantially increasing resource consumption and setup times. Furthermore, other media sessions, apart from telephone calls, should be capable of annunciation via the delivery of user selected media.

### BRIEF SUMMARY

A method, apparatus and computer program product are therefore provided for providing early session media to announce another session. In particular, a method, apparatus and computer program product are provided that enables a session initiator to select or otherwise provide media to the receiver of the session for the purpose of announcing the session request. Embodiments of the present invention may employ early session media related to session initiation protocol (SIP) that is provided to a receiver of another session such as, for example, a circuit switched (CS) call to announce the call. In this regard, the early session media includes a session indicating attribute, which enables the mobile terminal of the receiver of the call or other session to associate the early session media with the incoming call or other session.

In one exemplary embodiment, a method of providing early session media to announce another media session is provided. The method includes communicating an invitation for a target terminal to receive early session media content, providing the early session media content to the target terminal in response to acceptance of the invitation, and initiating the other media session with the target terminal in response to acceptance of the early session media content. The invitation includes an attribute that is indicative of a corresponding other media session associated with the early session media content.

In another exemplary embodiment, a method of receiving early session media to announce another media session is provided. The method includes receiving an invitation from an initiating terminal to receive early session media content, accepting the invitation, receiving the early session media content from the initiating terminal in response to acceptance of the invitation, and initiating the other media session with the initiating terminal in response to acceptance of the early session media content. The invitation includes an attribute that is indicative of a corresponding other media session associated with the early session media content.

In another exemplary embodiment, a computer program product for providing early session media to announce another media session is provided. The computer program product includes at least one computer-readable storage medium having computer-readable program code portions stored therein. The computer-readable program code portions include first, second and third executable portions. The first executable portion is for communicating an invitation for a target terminal to receive early session media content. The invitation includes an attribute that is indicative of a corresponding other media session associated with the early session media content. The second executable portion is for providing the early session media content to the target terminal in response to acceptance of the invitation. The third executable portion is for initiating the other media session with the target terminal in response to acceptance of the early session media content.

In another exemplary embodiment, a computer program product for receiving early session media to announce another media session is provided. The computer program product includes at least one computer-readable storage medium having computer-readable program code portions stored therein. The computer-readable program code portions include first, second, third and fourth executable portions. The first executable portion is for receiving an invitation from an initiating terminal to receive early session media content. The invitation includes an attribute that is indicative of a corresponding other media session associated with the early session media content. The second executable portion is for accepting the invitation. The third executable portion is for receiving the early session media content from the initiating terminal in response to acceptance of the invitation. The fourth executable portion is for initiating the other media session with the initiating terminal in response to acceptance of the early session media content.

In another exemplary embodiment, an apparatus for providing early session media to announce another media session is provided. The apparatus includes a processing element. The processing element is configured to communicate an invitation for a target terminal to receive early session media content, provide the early session media content to the target terminal in response to acceptance of the invitation, and initiate the other media session with the target terminal in response to acceptance of the early session media content. The invitation includes an attribute that is indicative of a corresponding other media session associated with the early session media content.

In another exemplary embodiment, an apparatus for receiving early session media to announce another media session is provided. The apparatus includes a processing element. The processing element is configured to receive an invitation from the initiating terminal to receive early session media content, accept the invitation, receive the early session media content from the initiating terminal in response to acceptance of the invitation, and initiate the other media session with the initiating terminal in response to acceptance of the early session media content. The invitation includes an attribute that is indicative of a corresponding other media session associated with the early session media content.

In another exemplary embodiment, a system for providing early session media to announce another media session is provided. The system includes an initiating terminal and a target terminal. The initiating terminal is capable of communication with a communications network. The target terminal is capable of communication with the initiating terminal via the communications network. The initiating terminal is configured to communicate an invitation for the target terminal to receive early session media content, provide the early session media content to the target terminal in response to acceptance of the invitation, and initiate the other media session with the target terminal in response to acceptance of the early session media content. The invitation includes an attribute that is indicative of a corresponding other media session associated with the early session media content.

Embodiments of the invention may provide a method, apparatus and computer program product for providing early session media to announce a call, which may be advantageously employed in telephony networks including both landline and wireless applications. In this regard, embodiments of the invention may be employed in mobile terminal devices, such as mobile telephones, fixed telephone devices, or in other electronic devices. As a result, for example, a caller may select the media which will announce a call made by the caller, in which the media selected includes an attribute tying the media to the call. Furthermore, the media selected may be transferred between the caller and receiver of the call with reduced setup time and resource consumption as compared to conventional techniques.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a simplified schematic diagram showing a system for providing early session media to announce another media session according to an exemplary embodiment of the present invention;

FIGS. 4-6 are control flow diagrams illustrating an exemplary method for providing early session media to announce another media session according to exemplary embodiments of the present invention; and

FIG. 7 is a flowchart according to an exemplary method for providing early session media to announce another media session according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

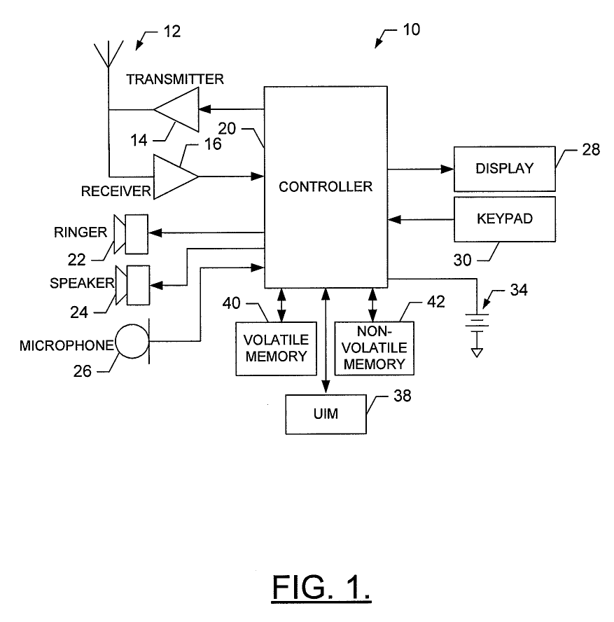

FIG. 1 illustrates a block diagram of a mobile terminal 10 that would benefit from embodiments of the present invention. It should be understood, however, that a mobile telephone as illustrated and hereinafter described is merely illustrative of one type of apparatus that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, music players, laptop computers and other types of audio, voice and text communications systems, can readily employ embodiments of the present invention. In addition to mobile devices, home appliances such as personal computers, game consoles, set-top-boxes, personal video recorders, TV receivers, loudspeakers, and others, can readily employ embodiments of the present invention. In addition to home appliances, data servers, web servers, databases, or other service providing components can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity element (UIM) 38. The UIM 38 is typically a memory device having a processor built in. The UIM 38 may include, for example, a subscriber identity element (SIM), a universal integrated circuit card (UICC), a universal subscriber identity element (USIM), a removable user identity element (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

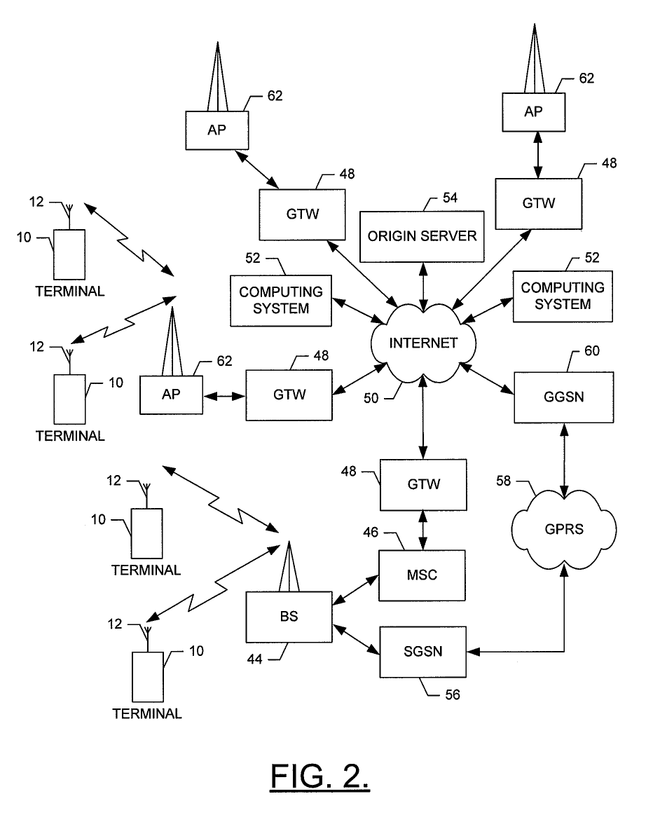

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

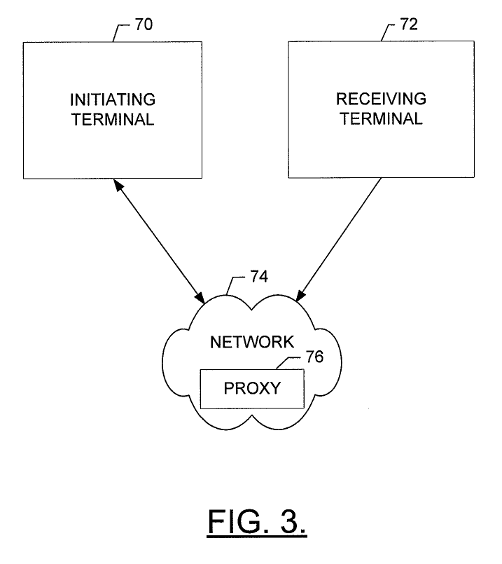

Additionally, the system of FIG. 2 may be capable of facilitating communications in accordance with Session Initiation Protocol (SIP). FIG. 3 is a simplified schematic diagram illustrating a system capable of supporting communication between network nodes such as an initiating terminal 70 and a receiving terminal 72 in which early session media provided in connection with SIP communications may be used to announce another media session via a network 74. In this regard, it should be noted that the network 74 may include any combination of wireless or wired networks such as, for example, private networks, cellular networks, public networks, etc. The network 74 may include at least one proxy 76, which may be associated with, for example, the network nodes of the network 74. The proxy 76 may be capable of receiving and forwarding SIP signaling messages, such as SIP signaling messages to and/or from the initiating terminal 70 and the receiving terminal 72. Although signals will be described hereinafter as passing between the initiating and receiving terminals 70 and 72, it should be understood that such signals are communicated via the network 74 and also via the at least one proxy 76 where applicable. It should also be understood that the initiating and receiving terminals 70 and 72 may be examples of the mobile terminal 10 of FIG. 1, or any other suitable communications device.

SIP could be thought to enable, for example, alerting the receiving terminal 72 of a session invitation such as a circuit switched (CS) voice call from the initiating terminal 70 by using media content instead of a conventional ringing tone. For example, an SIP INVITE message could carry media content to be used to announce a call to the receiving terminal 72. Alternatively, a reference could be made to a location of content to be used to announce the call, such as in an Alert-Info header. However, attaching content to the invitation message increases the use of resources of the signaling path and may slow down SIP signaling, thereby limiting content size. Additionally, referencing a location of content may slow down session setup times since the content will need to be fetched from the location. However, a promising SIP related implementation that could be used for announcing another media session without significant system slow downs and resource drains may involve use of SIP early session media.

In this regard, SIP may enable the initiating terminal 70 to provide the media content to the receiving terminal 72 as early session media. SIP early session enables SIP clients, such as the initiating and receiving terminals 70 and 72, to negotiate a multimedia stream that ends when the receiving terminal 72 accepts a session invitation. Thus, in practice, it may be deemed possible to send, for example, an audio stream from the initiating terminal 70 to the receiving terminal 72 and using the audio stream at the receiving terminal 72 to alert a user of the receiving terminal 72 of a call from the initiating terminal 70. However, using early session media in this way may not be effective without more because such a session invitation may fork, meaning that the invitation may be routed to multiple clients, which may send back media consuming large amounts of bandwidth. Thus, it may become difficult for the initiating terminal 70 to determine what media, if any, it should play, and the initiating terminal 70 may be forced to put some received streams on hold.

Accordingly, in an effort to eliminate the problems above, embodiments of the present invention provide for the use of early session media to announce another media session by including an attribute which ties the early session media to the other media session. In this regard, for example, early session capabilities may be determined in accordance with third generation partnership project (3GPP) standardized procedures (see e.g. 3GPP TR 24.879) regarding CSI (combining CS calls and Internet protocol multimedia subsystems (IMS)) and an extension may tie early session media to the CS call. Since only early session media capabilities are determined, setup time may be reduced. Early session media is defined as media provided during an SIP early session that terminates when the session invitation is accepted. As such, early session media could be, for example, audio content, video content, image content, text content, etc. It should be noted that although an embodiment of the present invention will be described in which the term “another media session” refers specifically to a CS call, any other media session could alternatively be included. For example, when referring to “another media session”, the other media session could be a link to an audio session such as voice over IP (VOIP), an audio/video session or any other suitable media session. Thus, the CS voice call is merely described for purposes of providing a detailed example and not for purposes of limitation.

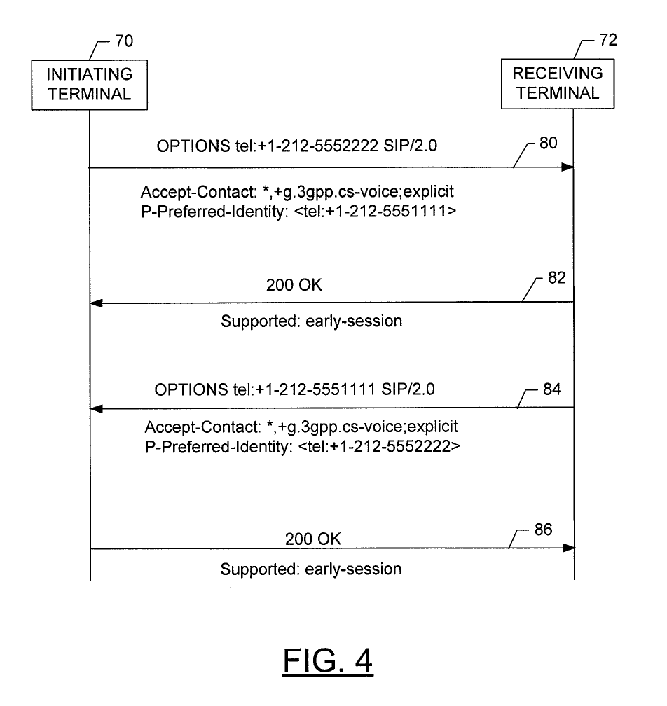

An exemplary embodiment of the invention will now be described with reference to FIGS. 4-6, which are control flow diagrams illustrating a method of providing early session media to announce another media session, although other methods of providing early session media to announce another media session may be provided in accordance with other embodiments. As shown in FIG. 4, the initiating terminal 70 may send a message 80 to the receiving terminal 72 using SIP OPTIONS according to CSI procedures. As such, the initiating terminal 70 may include the international e.164 number of the receiving terminal 72 in the OPTIONS request. The OPTIONS request may serve as a query as to the capabilities of the receiving terminal. The message 80 may include a declaration of the international e.164 number of the initiating terminal 70 as a preferred identity. It should be noted that although the initiating terminal 70 includes the international e.164 number of the receiving terminal 72 in the OPTIONS request in the example above, other identification mechanisms may also be employed such as a public SIP universal resource identifier (URI) of the receiving terminal 72.

The receiving terminal 72 provides a response 82 to the message 80 with a 200 OK response which indicates support for early session in the support header. The response 82 may include the international e.164 number of the receiving terminal 72 in the preferred identity header if the initiating terminal 70 used the public SIP URI as the request URI in the OPTIONS request in order to enable the initiating terminal 70 to make a CS voice call to the receiving terminal 72. The receiving terminal 72 then queries as to the capabilities of the initiating terminal 70 using a message 84. The message 84 includes an SIP OPTIONS request identifying the initiating terminal 70. The message 84 may also include a preferred identity of the receiving terminal 72. The initiating terminal 70 provides a response 86 to the message 84 with a 200 OK response which indicates support for early session in the support header. Accordingly, following receipt of the response 86 at the receiving terminal 72, the initiating and receiving terminals 70 and 72 have exchanged capabilities regarding support for early session media and the initiating terminal 70 is capable of making a CS voice call to the receiving terminal 72.

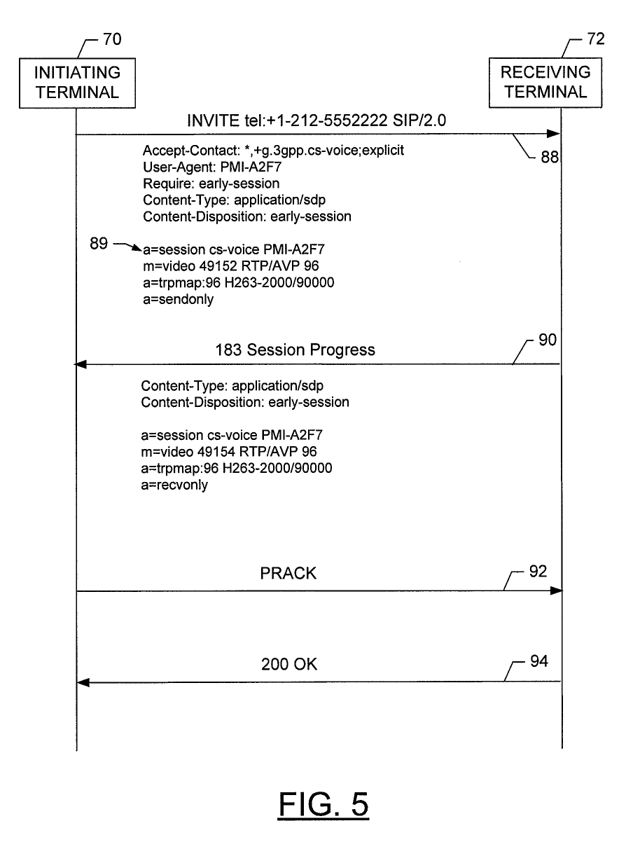

As shown in FIG. 5, after sending the response 86, the initiating terminal 70 offers early session media to the receiving terminal in SIP INVITE using the international e.164 number of the receiving terminal 72 as the request URI in message 88. The message 88 may also provide a personal mobile equipment identifier (i.e. PMI-A2F7) in a User-Agent header. A Require header may be employed to indicate that the early session media must go to a terminal that supports early session media. A Content-Disposition header may indicate that media received only occurs until the receiving terminal 72 generates a final response. The body of the INVITE message may be used to include a session description protocol (SDP) attribute 89 which refers to the CS voice call. Without the SDP attribute 89, the receiving terminal 72 would not be aware of any association between the early session media content and the CS voice call (or other media session to which such an SDP attribute may refer). As such, without the SDP attribute 89, the receiving terminal 72 would expect that the early session media was for the same SIP session that is initiated with the message. Media would continue until the receiving terminal 72 sends a 200 OK message for INVITE, which could be immediately. The SDP attribute 89 (i.e., a=session cs-voice PMI-A2F7) may include a portion indicating the session type (e.g., cs-voice in the present example) and a portion indicating session type specific parameters (e.g., the personal mobile equipment identifier PMI-A2F7 in the present example). The SDP attribute 89 may also be registered with the Internet Assigned Numbers Authority (IANA). As stated above, cs-voice is merely listed as an exemplary session indicator and the SDP attribute 89 may alternatively include any other non-SIP media session such as another voice session, an audio session, a video session such as a cs-video session, etc. Additionally, the SDP attribute 89 may include additional data carried in order to initiate the other non-SIP media session.

The message 88 provides an invitation to the receiving terminal 72, thereby offering the early session media to the receiving terminal 72 may be accepted with a 183 Session Progress message 90. In an exemplary embodiment, the receiving terminal 72 may include a list of persons from which early session media may be accepted. Accordingly, issuance of the 183 Session Progress message 90 accepting the early session media invitation may be conditioned upon inclusion of the initiating terminal 70 on the list of persons from which the receiving terminal 72 will accept early session media. Additionally or alternatively, the acceptance by the receiving terminal 72 of the early session media invitation may be conditioned upon presence information associated with the receiving terminal 72. For example, if the presence information associated with the receiving terminal 72 indicates that the user of the receiving terminal 72 is in a meeting or otherwise unavailable, the early session media invitation may not be accepted by the receiving terminal 72. If the early session media invitation is not accepted by the receiving terminal 72, the initiating terminal 70 may receive an error message or other such indication informing the initiating terminal 70 of the failure to receive acceptance of the early session media invitation. In an exemplary embodiment, the initiating terminal 70 may also receive an explanation related to the failure to receive acceptance of the early session media invitation. For example, such an explanation may simply indicate the failure was due to presence information or, more specifically, the explanation may specify that the user of the receiving terminal 72 is in a meeting, the session has been rejected, the sender of the early media is not authorized to send early session media to this recipient, or numerous other specific indications.

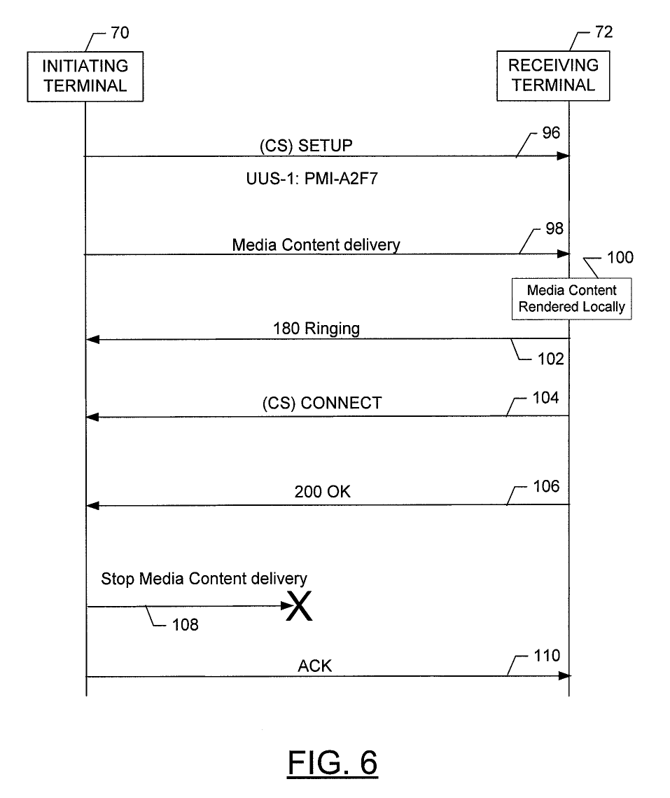

In response to receipt of the 183 Session Progress message 90, the initiating terminal 70 may issue a provisional response acknowledgement (PRACK) 92, to which the receiving terminal may issue a 200 OK response 94 to the initiating terminal 70. The initiating terminal may then commence setup of the CS voice call (or other media session) and actually deliver the media content during the early session as shown, for example, in FIG. 6.

Referring now to FIG. 6, the initiating terminal 70 may attempt to initiate the CS voice call (or other media session) by issuing a SETUP message 96. The SETUP message 96 may include the personal mobile equipment identifier (i.e., PMI-A2F7) as a UUS-1 information element. The personal mobile equipment identifier allows the receiving terminal 72 to tie the early session media that has carried the personal mobile equipment identifier to the CS voice call being set up. Simultaneously or in series with the SETUP message 96, the initiating terminal 70 may begin delivering the media content 98 to the receiving terminal 72. Accordingly, as the receiving terminal 70 receives the media content 98, local media content rendering 100 at the receiving terminal 72 serves to announce the CS voice call to the user of the receiving terminal 72. Alternatively, the receiving terminal 72 may render the media content locally in combination with a local ringing tone. As the media content is rendered at the receiving terminal 72, the receiving terminal 72 provides a 180 Ringing message 102 to the initiating terminal 70 to indicate that the user of the receiving terminal 72 is being alerted of the incoming CS voice call via the media content 98 which has been delivered as early session media. The delivery of the media content 98 may be, for example, via a video stream, an image, an audio stream, or any other media that may be rendered either visually, audibly, mechanically or otherwise presented in a manner that is perceptible to the user of the receiving terminal 72. Furthermore, although the media content 98 could be retrieved from network servers, the media content 98 may also be retrieved from a memory of the initiating terminal 70 or even produced real time at the initiating terminal 70 for transmission to the receiving terminal 72 as early session media, thereby reducing setup times for establishing communications between the initiating and receiving terminals 70 and 72.

If the receiving terminal 72 accepts the CS voice call, a (CS) CONNECT message 104 will be sent to the initiating terminal 70 to indicate that the CS voice call has been accepted and to connect the receiving terminal 72 and the initiating terminal 70 for the commencement of a CS voice session. It should be emphasized again that although the present example relates to a CS voice session, any other media session may similarly be initiated using an attribute provided in the early media content that is used to announce or invite a recipient to engage a sending device in the other media session.

A 200 OK response 106 may be sent either in parallel or in series with the (CS) CONNECT message 104 in order to terminate the delivery of the media content 98. When the 200 OK response 106 is received at the initiating terminal 70, the delivery of the media content is stopped as indicated at operation 108. In response to the sending of an ACK message 110 from the initiating terminal 70 to the receiving terminal 72, the early session is terminated and a SIP session is established between the initiating and receiving terminals 70 and 72. However, there is no media transfer during the SIP session since the initiating and receiving terminals 70 and 72 are engaged in the CS voice call and no such media transfer has been negotiated via a SIP session media capability negotiation. Rather, the only media transfer capability negotiation which occurred was the early session media capability exchange. Accordingly, the SIP session can be torn down or, alternatively, the SIP session could be used to transfer media following a media negotiation for media transfer between the initiating and receiving terminals 70 and 72 during the SIP session. Such media exchange could occur following the CS voice call, or even during the CS voice call.

If, instead of accepting the call by issuing the (CS) CONNECT message 104, the call for setup of the other media session (i.e. the (CS) SETUP message 96 above) is terminated, redirected, or otherwise rejected, the receiving terminal 72 may reject the early session media content and indicate such rejection to the initiating terminal 70 via standard SIP procedures. If, however, no answer is received at the receiving terminal 72, the media content 98 may be delivered to the receiving terminal 72 for a predetermined time after which the delivery of the media content 98 may timeout. In response to the timeout, the receiving terminal 72 may indicate to the initiating terminal 70 that no connection could be made. Accordingly, following receipt of the 180 Ringing message 102, the initiating terminal 70 may receive a timeout message to indicate that the initiating terminal 70 should stop delivery of the media content. The initiating terminal 70 may then be directed to the voicemail of the receiving terminal 72 or otherwise informed of the timeout condition. Thus, acceptance of the media content 98 provided during the early session serves to initiate or connect the initiating and receiving terminals 70 and 72 for the CS voice call or other media session. However, rejection of the media content 98, or rendering of the media content 98 without acceptance will not connect the CS voice call or other media session.

Accordingly, a system is provided in which delays due to fetching media content from a network by the receiving terminal 72 may be eliminated since media content may be provided directly from the initiating terminal 70 and no configuration of terminals to support such fetching is required. Additionally, bandwidth and server resources of the signaling path are conserved. However, despite such reductions in delays and resource consumption, the initiating terminal 70 is still provided with a robust capability for alerting the user of the receiving terminal 72 of another media session via streaming audio, video or other media which is tied to the other media session by an attribute carried in combination with the early session media used to announce the other media session.

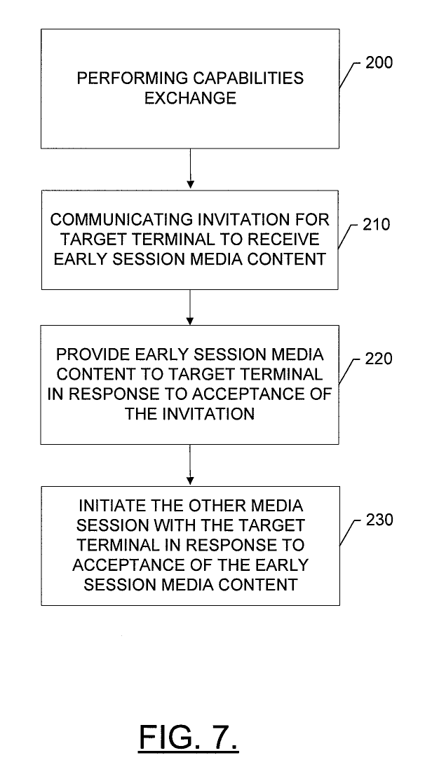

FIG. 7 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal such as, for example, the controller 20 of FIG. 1. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing early session media to announce another media session, as shown in FIG. 7, may include an optional initial operation of determining whether a target (i.e. receiving) terminal supports early session media at operation 200. Such determination may be made based on performing a capabilities exchange between an initiating terminal and the target terminal. An invitation to receive early session media content may be communicated in response to a determination that the target terminal supports early session media at operation 210. The invitation may include an attribute that is indicative of a corresponding other media session associated with the early session media content. At operation 220, the early session media content is provided in response to acceptance of the invitation by the target terminal. At operation 230, the other media session is initiated in response to acceptance of the early session media content. It should be noted that the initiating terminal may attempt to send the early session media content to the target terminal without having conducted the capability determination operation. However, a user's experience may generally be enhanced by determining the capabilities in advance to avoid failed attempts to deliver the early session media content.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
communicating an invitation for a target terminal to receive early session media content, the invitation including an attribute that is indicative of a corresponding other media session associated with the early session media content;
providing the early session media content to the target terminal in response to acceptance of the invitation; and
initiating the other media session with the target terminal in response to acceptance of the early session media content.

2. A method according to claim 1, further comprising an initial operation of performing a capability exchange regarding support for early session media with the target terminal.

3. A method according to claim 2, wherein communicating the invitation is performed in response to a determination, via the capability exchange, that the target terminal supports early session media.

4. A method according to claim 1, wherein providing the early session media content comprises providing at least one of:
text content;
audio content;
video content; and
image content.

5. A method according to claim 1, further comprising terminating provision of the early session media content in response to acceptance of the early session media content.

6. A method according to claim 1, wherein initiating the other media session comprises initiating a voice session with the target terminal.

7. A method comprising:
receiving an invitation from an initiating terminal to receive early session media content, the invitation including an attribute that is indicative of a corresponding other media session associated with the early session media content;
accepting the invitation;
receiving the early session media content from the initiating terminal in response to acceptance of the invitation; and
initiating the other media session with the initiating terminal in response to acceptance of the early session media content.

8. A method according to claim 7, further comprising an initial operation of exchanging capabilities regarding support for early session media with the initiating terminal.

9. A method according to claim 7, wherein receiving the early session media content comprises receiving at least one of:
text content;
audio content;
video content; and
image content.

10. A method according to claim 7, wherein initiating the other media session comprises initiating a voice session with the initiating terminal.

11. A method according to claim 7, wherein accepting the invitation is performed responsive to a determination that the initiating terminal is an authorized provider of early session media.

12. A method according to claim 7, wherein accepting the invitation is performed based on presence information.

13. A computer program product comprising at least one computer-readable storage medium having computer-readable program code portions stored therein, the computer-readable program code portions comprising:
a first executable portion for communicating an invitation for a target terminal to receive early session media content, the invitation including an attribute that is indicative of a corresponding other media session associated with the early session media content;
a second executable portion for providing the early session media content to the target terminal in response to acceptance of the invitation; and
a third executable portion for initiating the other media session with the target terminal in response to acceptance of the early session media content.

14. A computer program product according to claim 13, further comprising a fourth executable instruction for an initial operation of performing a capability exchange regarding support for early session media with the target terminal.

15. A computer program product according to claim 14, wherein the first executable portion is performed in response to a determination, via the capability exchange, that the target terminal supports early session media.

16. A computer program product according to claim 13, wherein the second executable portion includes instructions for providing early session media content comprising at least one of:
text content;
audio content;
video content; and
image content.

17. A computer program product according to claim 13, further comprising a fourth executable portion for terminating the provision of the early session media content in response to acceptance of the early session media content.

18. A computer program product according to claim 13, wherein the third executable portion includes instructions for initiating the other media session comprising a voice session with the target terminal.

19. A computer program product comprising at least one computer-readable storage medium having computer-readable program code portions stored therein, the computer-readable program code portions comprising:
a first executable portion for receiving an invitation from an initiating terminal to receive early session media content, the invitation including an attribute that is indicative of a corresponding other media session associated with the early session media content;
a second executable portion for accepting the invitation;
a third executable portion for receiving the early session media content from the initiating terminal in response to acceptance of the invitation; and
a fourth executable portion for initiating the other media session with the initiating terminal in response to acceptance of the early session media content.

20. A computer program product according to claim 19, further comprising a fifth executable portion for the initial operation of exchanging capabilities regarding support for early session media with an initiating terminal.

21. A computer program product according to claim 19, wherein the third executable portion includes instructions for receiving the early session media content comprising at least one of:
text content;
audio content;
video content; and
image content.

22. A computer program product according to claim 19, wherein the fourth executable portion includes instructions for initiating a voice session with the initiating terminal.

23. A computer program product according to claim 19, wherein the second executable portion includes instructions for accepting the invitation responsive to a determination that the initiating terminal is an authorized provider of early session media.

24. A computer program product according to claim 19, wherein the second executable portion includes instructions for accepting the invitation based on presence information.

25. An apparatus comprising a processing element configured to:
communicate an invitation for a target terminal to receive early session media content, the invitation including an attribute that is indicative of a corresponding other media session associated with the early session media content;
provide the early session media content to the target terminal in response to acceptance of the invitation; and
initiate the other media session with the target terminal in response to acceptance of the early session media content.

26. An apparatus according to claim 25, wherein the processing element is further configured to determine whether the target terminal supports early session media by performing a capability exchange with the target terminal.

27. An apparatus according to claim 25, wherein the processing element is further configured to provide the early session media content comprising at least one of:
text content;
audio content;
video content; and
image content.

28. An apparatus according to claim 25, wherein the other media session comprises a voice session with the target terminal.

29. An apparatus comprising a processing element configured to:
receive an invitation from the initiating terminal to receive early session media content, the invitation including an attribute that is indicative of a corresponding other media session associated with the early session media content;
accept the invitation;
receive the early session media content from the initiating terminal in response to acceptance of the invitation; and
initiate the other media session with the initiating terminal in response to acceptance of the early session media content.

30. An apparatus according to claim 29, wherein the early session media content comprises at least one of:
text content;
audio content;
video content; and
image content.

31. An apparatus according to claim 29, wherein the other media session comprises a voice session with the initiating terminal.

32. An apparatus according to claim 29, wherein the processing element is further configured to accept the invitation responsive to a determination that the initiating terminal is an authorized provider of early session media.

33. An apparatus according to claim 29, wherein the processing element is further configured to accept the invitation based on presence information.

34. An apparatus according to claim 29, wherein the processing element is further configured to exchange capabilities regarding support for early session media with the initiating terminal.

35. A system comprising:
an initiating terminal capable of communication with a communications network; and
a target terminal capable of communication with the initiating terminal via the communications network,
wherein the initiating terminal is configured to:
communicate an invitation for the target terminal to receive early session media content, the invitation including an attribute that is indicative of a corresponding other media session associated with the early session media content;
provide the early session media content to the target terminal in response to acceptance of the invitation; and
initiate the other media session with the target terminal in response to acceptance of the early session media content.

36. A system according to claim 35, wherein the early session media content comprises at least one of:
text content;
audio content;
video content; and
image content.

37. A system according to claim 35, wherein the other media session comprises a voice session with the initiating terminal.

38. A system according to claim 35, wherein the target terminal is further configured to accept the invitation responsive to a determination that the initiating terminal is an authorized provider of early session media.

39. A system according to claim 35, wherein the target terminal is further configured to accept the invitation based on presence information.
